(19) United States
(12) Patent Application Publication
(10) Pub. No.: US 2026/0274255 A1
(43) Pub. Date: Sep. 17, 2026

(54) DRIVING ASSISTANCE DEVICE AND PROGRAM

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Masahide KUWATA, Tokyo (JP); Yuji KOSAKA, Tokyo (JP); Takahiro NAKANO, Tokyo (JP)

(21) Appl. No.: 19/562,059

(22) Filed: Mar. 10, 2026

(30) Foreign Application Priority Data
Mar. 14, 2025 (JP) 2025-041260

(51) Int. Cl. B60W 30/14; B60W 30/095; B60W 30/16; G06V 20/58

(52) U.S. Cl. CPC B60W 30/143; B60W 30/0956; B60W 30/16; G06V 20/584; B60W 2420/403; B60W 2554/4023; B60W 2554/4042; B60W 2554/4045; B60W 2554/802

(57) ABSTRACT

When an other vehicle cuts into an own lane in which an own vehicle is traveling from a lane adjacent to the own lane in which the own vehicle is traveling, an ECU performs driving assistance processing of the own vehicle regarding a cutting-in of the other vehicle. The ECU includes a turn signal determination unit that determines whether a turn signal has been turned on in the other vehicle on the own lane side, a cut-in position specifying unit that specifies a cut-in position in the own lane at which the other vehicle will cut in when it is determined that the turn signal has been turned on in the other vehicle, and a driving assistance control unit that performs driving assistance processing based on the cut-in position specified by the cut-in position specifying unit.

### CROSS-REFERENCE TO RELATED APPLICATION

This application is based on and claims the benefit of priority from earlier Japanese Patent Application No. 2025-41260 filed on Mar. 14, 2025, the descriptions of which are incorporated herein by reference.

### TECHNICAL FIELD

The disclosure in this specification relates to a driving assistance device and a program.

### BACKGROUND

Conventionally, when another vehicle cuts in front of an own vehicle in an own lane from a lane adjacent to the own lane, a technology is known for controlling a traveling speed of the own vehicle relative to the other vehicle. For example, the technology described in JP 2019-55675 A detects a driving behavior of an adjacent vehicle traveling in an adjacent lane, and determines from the detected driving behavior of the adjacent vehicle whether the adjacent vehicle will change lanes into a driving lane of the own vehicle, and unless it is determined that the adjacent vehicle will change lanes into the driving lane of the own vehicle, an automatic driving control of the own vehicle continues without taking into account the presence of the adjacent vehicle. Whether the adjacent vehicle will change lanes into the lane in which the own vehicle is traveling is estimated from at least one of a driving posture of the adjacent vehicle or changes in the driving posture over time, whether a turn signal is flashing, or a relative position of the adjacent vehicle to the own vehicle and an amount of change in the relative position. The technology described in JP 2019-55675 A is designed to suppress unnecessary driving control from being performed by determining whether the adjacent vehicle is changing lanes.

### SUMMARY

The driving assistance device of the present disclosure includes:
a driving assistance device that, when an other vehicle cuts into an own lane in which an own vehicle is traveling from a lane adjacent to the own lane in which the own vehicle is traveling, performs driving assistance processing of the own vehicle regarding a cutting-in of the other vehicle, the driving assistance device including:
a turn signal determination unit that determines whether a turn signal has been turned on in the other vehicle on the own lane side;
a cut-in position specifying unit that specifies a cut-in position in the own lane at which the other vehicle will cut in when it is determined that the turn signal has been turned on in another vehicle; and
a driving assistance control unit that performs driving assistance processing based on the cut-in position specified by the cut-in position specifying unit.

### BRIEF DESCRIPTION OF THE DRAWINGS

The above features of the present disclosure will be made clearer by the following detailed description, given referring to the appended drawings. In the accompanying drawings:

FIG. 1 shows a schematic diagram of a vehicle driving assistance system;

FIG. 2 shows a diagram for explaining a scene in which another vehicle cuts in;

FIG. 3 shows an example of a scene in which the other vehicle cuts in;

FIG. 4 shows a diagram of a relationship between a speed difference ΔV and a distance threshold value Dx;

FIG. 5 shows an example of a scene in which the other vehicle cuts in;

FIG. 6 shows a flowchart of a processing procedure for driving assistance control;

FIG. 7 shows a flowchart of a procedure for detecting a cut in behind the own vehicle;

FIG. 8 shows a flowchart of a procedure for detecting a cut in front of the own vehicle; and

FIG. 9 shows an example of a scene in which the other vehicle cuts in.

### DETAILED DESCRIPTION OF THE PREFERRED EMBODIMENTS

For example, if another vehicle (adjacent vehicle) traveling in the adjacent lane turns on its turn signal (directional indicator) on a side of the own lane, it is determined that the other vehicle has indicated that it wants to cut in on the own lane, and the own vehicle will slow down or take other measures to prepare for the other vehicle cutting in. However, even if the other vehicle traveling in the adjacent lane turns on its turn signal, the other vehicle does not necessarily cut in front of the own vehicle at a position that would require the own vehicle to slow down or the like. For example, the other vehicle may cut in behind the own vehicle after turning on its turn signal, or cut in front of a preceding vehicle when the preceding vehicle is traveling ahead of the own vehicle. In such a case, it is conceivable that the own vehicle may be decelerated unnecessarily.

The present disclosure has been made in consideration of the above circumstances, and it is an object of the present disclosure to provide a driving assistance device and program that can appropriately provide driving assistance to a vehicle when another vehicle in an adjacent lane suggests cutting into an own lane.

The driving assistance device of the present disclosure includes:
a driving assistance device that, when an other vehicle cuts into an own lane in which an own vehicle is traveling from a lane adjacent to the own lane in which the own vehicle is traveling, performs driving assistance processing of the own vehicle regarding a cutting-in of the other vehicle, the driving assistance device including:
a turn signal determination unit that determines whether a turn signal has been turned on in the other vehicle on the own lane side;
a cut-in position specifying unit that specifies a cut-in position in the own lane at which the other vehicle will cut in when it is determined that the turn signal has been turned on in another vehicle; and
a driving assistance control unit that performs driving assistance processing based on the cut-in position specified by the cut-in position specifying unit.

When the other vehicle in the lane adjacent to the own vehicle turns on its turn signal toward the own lane side, there is a possibility that the other vehicle will then cut in front of the own vehicle. Therefore, driving assistance processing such as decelerating the vehicle and notifying a driver of the possibility of the other vehicle cutting in is performed in preparation for the other vehicle cutting in. However, the other vehicle does not necessarily cut in immediately in front of the own vehicle, and it is possible that driving assistance processing may be performed unnecessarily. Taking this into consideration, in the above configuration, when it is determined that the turn signal of the other vehicle has been turned on on the own lane side, the cut-in position of the other vehicle in the own lane is identified, and driving assistance processing is performed based on the identified cut-in position. In this case, if the other vehicle does not cut in immediately in front of the own vehicle, unnecessary driving assistance processing is suppressed from being performed. This makes it possible to realize the driving assistance device that performs appropriate driving assistance processing in the own vehicle.

Hereinafter, a driving assistance device according to an embodiment of the present disclosure will be described with reference to the drawings. In the present embodiment, a driving assistance system is constructed to provide driving assistance to vehicles such as passenger cars, trucks, and buses.

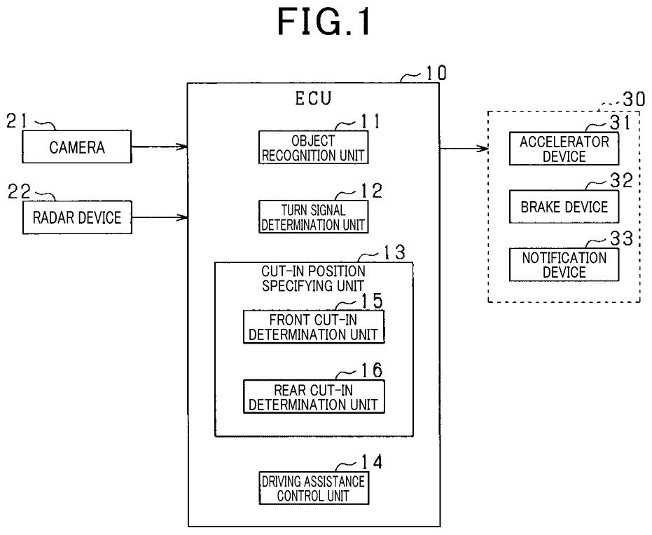

As shown in FIG. 1, the driving assistance system according to the present embodiment includes an ECU (Electronic Control Unit) 10, a camera 21, a radar device 22, and controlled devices 30 as the driving assistance device. The controlled devices 30 include an accelerator device 31, a brake device 32 and a notification device 33.

The camera 21 is an on-board camera such as a known CCD camera. The camera 21 is mounted in a cabin of an own vehicle near a top of a windshield and is capable of capturing images of a predetermined range in front of the own vehicle. The camera 21 continuously captures images at predetermined time intervals (predetermined cycles) and transmits the captured images to the ECU 10 at the predetermined cycles. The camera 21 may be a monocular camera or a stereo camera.

The radar device 22 is a distance measuring device that transmits high-frequency signals in the millimeter wave band. The radar device 22 is mounted, for example, at the front end and rear end of the own vehicle, and measures the distance to objects around the own vehicle. Specifically, the radar device 22 transmits a search wave at a predetermined interval and receives a reflected wave using a plurality of antennas, and measures the distance to an object based on the time the search wave was transmitted and the time the reflected wave was received. In addition, the radar device 22 also calculates the direction of an object based on a phase difference between the reflected waves received by the plurality of antennas. It is possible to identify a relative position of the object with respect to the own vehicle by calculating the distance to the object and the direction of the object.

The ECU 10 is an electronic control unit equipped with a well-known microcomputer including a CPU as a processor, a ROM, a RAM, a flash memory, and the like. The microcomputer provides various computing functions. The functions provided by the microcomputer can be provided by software recorded in a physical memory device and a computer that performs the software, software alone, hardware alone, or a combination of these. The microcomputer performs a program stored in, for example, a non-transitory tangible storage medium that serves as a storage unit provided within the microcomputer. The programs include, for example, programs related to object recognition processing for recognizing objects around the own vehicle, and processing for avoiding collisions with objects around the own vehicle or mitigating damage in the event of a collision. When a program is executed, the method corresponding to the program is executed. The storage unit is, for example, a non-volatile memory. Note that the program stored in the storage unit may be updated via a network such as the Internet, for example.

The ECU 10 acquires object detection information from the camera 21 and the radar device 22, and recognizes objects around the own vehicle based on this information. Specifically, a relative position and an existence area of an object are calculated as image information based on the distance to the object and the direction of the object calculated from the camera image, and the relative position and the existence area of the object are calculated as radar information based on the distance to the object and the direction of the object contained in the distance information obtained from the radar device 22, and the object is recognized by fusing this image information and radar information. At this time, the object is recognized based on whether the area in which the object exists included in the image information overlaps with the area in which the object exists included in the radar information. However, in the present embodiment, an object recognition method is arbitrary, and it is possible to recognize an object based on, for example, only the object detection information from the camera 21 or only the object detection information from the radar device 22 among the object detection information from the camera 21 and the radar device 22.

The ECU 10 performs ACC (adaptive cruise control) as a driving assistance control for the own vehicle. Specifically, the ECU 10 performs constant speed driving control to drive the own vehicle at a constant speed based on a target speed set by the driver, and also performs follow-up control to make the own vehicle follow a preceding vehicle while maintaining a predetermined target distance from the preceding vehicle when there is a preceding vehicle traveling ahead of the own vehicle in the direction of travel. In this case, when the ACC control is being performed, the ECU 10 searches for a preceding vehicle to be followed up ahead in the traveling direction of the own vehicle. Then, if there is no preceding vehicle, the own vehicle is made to travel at a constant target speed. In addition, if there is a preceding vehicle, the own vehicle is caused to travel at the target speed as an upper limit speed while maintaining an inter-vehicle distance to the preceding vehicle at a target inter-vehicle distance. At this time, the ECU 10 uses the controlled device 30 to adjust the driving force and braking force of the own vehicle in order to control the speed of the own vehicle. According to the ACC control, it is possible to control the vehicle speed even when the driver is not depressing an accelerator pedal.

In the present embodiment, the accelerator device 31 and the brake device 32 are mounted as the controlled devices 30 on the vehicle. The accelerator device 31 is an engine or a motor as a vehicle power source, and when the driver operates the accelerator, a driving force is applied to the own vehicle in response to a control command from the ECU 10. The brake device 32 is provided on each wheel of the vehicle, and applies a braking force to the own vehicle in response to a control command from the ECU 10 when the driver operates the brake.

Note that the ACC control can be turned on and off by the driver. When the driver turns on a set switch, for example, the ECU 10 performs the ACC control. In addition, when a predetermined release condition is met, such as when the driver turns off the set switch, the ACC control by the ECU 10 is stopped.

The notification device 33 includes an audio device that notifies by voice and a display device that notifies by display. The ECU 10 executes warnings and the like using the notification device 33 based on the driving state of the own vehicle for the purpose of avoiding danger and assisting driving.

In addition, in the present embodiment, when another vehicle cuts in front of the own vehicle, the driving assistance control of the own vehicle is performed in accordance with a cutting-in behavior of the other vehicle. The driving assistance control of the own vehicle when another vehicle cuts in will be described in detail below.

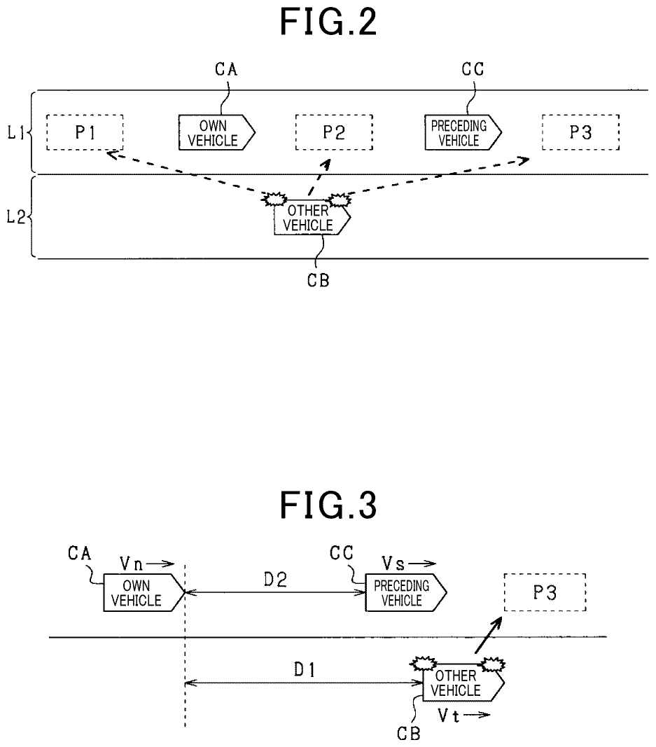

FIG. 2 is a diagram showing a scene in which another vehicle cuts in. In FIG. 2, an own vehicle CA is traveling in an own lane L1, and another vehicle CB is traveling in an adjacent lane L2 adjacent to the own lane L1. The own lane L1 and the adjacent lane L2 are lanes in which the vehicle travels in the same direction, and the lanes L1 and L2 are separated by dividing lines such as white lines.

In this cut-in scene, a preceding vehicle CC is traveling ahead of the own vehicle CA in the own lane L1, and the own vehicle CA is performing the ACC control with the preceding vehicle CC as ta follow-up target. In addition, the other vehicle CB is traveling in the adjacent lane L2, ahead of the own vehicle CA, and turn signals of the other vehicle CB are lit on the side of the own lane L1 (to the left of the other vehicle CB), indicating that the vehicle will cut in to the own lane L1 (in other words, indicating that the vehicle will change lanes). In this case, the own vehicle CA assumes that the other vehicle CB will cut in immediately in front of the own vehicle CA, and performs a cut-in notification and deceleration process as driving assistance processing.

However, the other vehicle CB does not necessarily cut in immediately in front of the own vehicle CA, but may cut in front of the preceding vehicle CC or behind the own vehicle CA. In FIG. 2, a first position P1 is behind the own vehicle CA, a second position P2 is immediately in front of the own vehicle CA, and a third position P3 is in front of the preceding vehicle CC. When the left turn signal of the other vehicle CB is turned on, it is conceivable that the other vehicle CB will cut in at any one of the first to third positions P1 to P3.

Here, when the other vehicle CB cuts in at the second position P2, it is necessary to maintain a sufficient distance between the other vehicle CB and the own vehicle in the own lane L1. Therefore, deceleration control is performed in the own vehicle CA.

On the other hand, there is a concern that the driver may feel uncomfortable due to unnecessary deceleration of the own vehicle CA when the other vehicle CB cuts in at the first position P1. In addition, there is a concern that unnecessary deceleration of the own vehicle CA may disrupt smooth traffic flow on the road and cause traffic congestion. Therefore, it is desirable that unnecessary deceleration control is not performed in the own vehicle CA when the other vehicle CB cuts in at the first position P1.

Similarly, there is a concern that the driver may feel uncomfortable due to unnecessary deceleration of the own vehicle CA when the other vehicle CB cuts in at the third position P3. Therefore, it is desirable that unnecessary deceleration control is not performed in the own vehicle CA when the other vehicle CB cuts in at the third position P3. Note that when the other vehicle CB cuts in at the third position P3, the preceding vehicle CC decelerates in response to the cutting in of the other vehicle CB, and the own vehicle CA decelerates in accordance with the deceleration of the preceding vehicle CC. In other words, if the own vehicle CA is in the ACC control mode, speed control is performed to maintain a constant inter-vehicle distance from the preceding vehicle CC.

When the other vehicle CB turns on its turn signal indicating that it is about to cut in, if driving assistance is provided to the own vehicle CA regardless of the subsequent cutting-in position of the other vehicle CB, unnecessary driving assistance will be provided. Therefore, in the present embodiment, when the turn signal of the other vehicle CB is turned on, indicating that the other vehicle CB is about to cut in, the cut-in position of the other vehicle CB in the own lane L1 is identified, and driving assistance processing is performed according to that cut-in position.

FIG. 1 shows control functions of the ECU 10. The ECU 10 includes an object recognition unit 11, a turn signal determination unit 12, a cut-in position specifying unit 13, and a driving assistance control unit 14.

The object recognition unit 11 uses detection information from the camera 21 and the radar device 22 to recognize objects present around the own vehicle CA. This allows the other vehicle CB traveling in the adjacent lane L2 and the preceding vehicle CC traveling ahead of the own vehicle CA in the own lane L1 to be recognized. Recognition information of the other vehicle CB includes information on the distance and relative speed between the own vehicle CA and the other vehicle CB. In addition, recognition information of the preceding vehicle CC also includes information on the distance and relative speed between the own vehicle CA and the preceding vehicle CC.

The turn signal determination unit 12 determines whether a turn signal has been turned on on the own lane L1 side of the other vehicle CB traveling in the adjacent lane L2. Specifically, a camera image is used, for example, and by analyzing the other vehicle CB in the image, it is determined that the turn signal of the other vehicle CB is on.

When it is determined that the turn signal of the other vehicle CB is turned on, the cut-in position specifying unit 13 specifies a cut-in position at which the other vehicle CB will cut in on the own lane L1. Specifically, the cut-in position specifying unit 13 has a front cut-in determination unit 15 that determines whether the other vehicle CB will cut in front of the preceding vehicle CC, and a rear cut-in determination unit 16 that determines whether the other vehicle CB will cut in behind the own vehicle CA in the own lane L1.

The front cut-in determination unit 15 determines whether the other vehicle CB will cut in front of the preceding vehicle CC based on the inter-vehicle distance between the own vehicle CA and the other vehicle CB in the direction of travel of the own vehicle CA and the inter-vehicle distance between the own vehicle CA and the preceding vehicle CC in the direction of travel of the own vehicle CA.

An example of an assumed scenario in which the other vehicle CB cuts in is shown in FIG. 3. In FIG. 3, a traveling speed of the own vehicle CA is an own vehicle speed Vn, a traveling speed of the other vehicle CB is another vehicle speed Vt, and a traveling speed of the preceding vehicle CC is a preceding vehicle speed Vs. An inter-vehicle distance between the own vehicle CA and the other vehicle CB is D1, and an inter-vehicle distance between the own vehicle CA and the preceding vehicle CC is D2. The inter-vehicle distance D1 is a vertical distance in the direction of vehicle travel from a front end of the own vehicle CA to a rear end of the other vehicle CB, and the inter-vehicle distance D2 is a vertical distance in the direction of vehicle travel from the front end of the own vehicle CA to a rear end of the preceding vehicle CC.

The front cut-in determination unit 15 determines whether the other vehicle CB will cut in front of the preceding vehicle CC based on whether the following equation (1) is satisfied.

$$D 1 - D 2 > Dx \qquad ( 1 )$$

In the equation (1), Dx is a distance threshold value, which may be, for example, a value of about 0 to 2 or 3 m. In addition, the distance threshold value Dx is a threshold value for determining the separation distance between the rear end of the other vehicle CB and the rear end of the preceding vehicle CC.

If the above equation (1) is satisfied, it is determined that the other vehicle CB will cut in front of the preceding vehicle CC (i.e., the third position P3). In addition, if the above equation (1) is not established, it is determined that the other vehicle CB will cut in immediately before the own vehicle CA, not in front of the preceding vehicle CC.

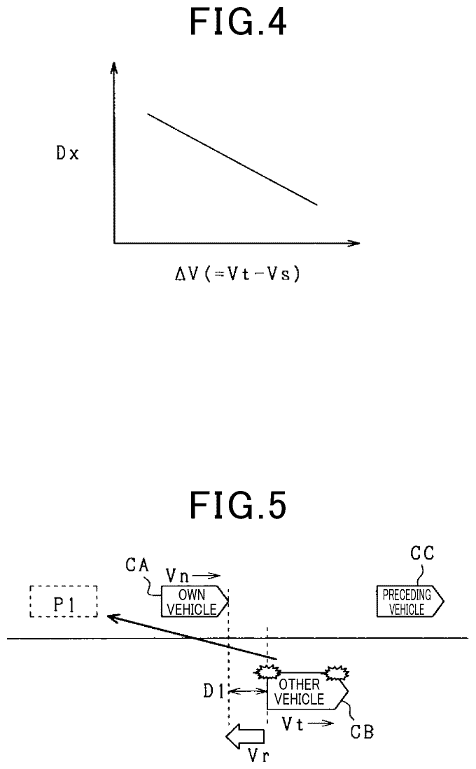

If the traveling speed of the other vehicle CB is higher than that of the preceding vehicle CC, even if the difference between the rear end of the preceding vehicle CB and the rear end of the preceding vehicle CC is small, or even if the other vehicle CB is positioned further back than the preceding vehicle CC, it is possible that the other vehicle CB will overtake the preceding vehicle CC and cut in front of the preceding vehicle CC. Taking this into consideration, it is preferable to set the distance threshold value Dx to a smaller value as the other vehicle speed Vt is greater than the preceding vehicle speed Vs. Specifically, using the relationship in FIG. 4, the greater the speed difference ΔV (=Vt−Vs) between the other vehicle speed Vt and the preceding vehicle speed Vs, the smaller the distance threshold value Dx is set to be. As a result, the larger the speed difference ΔV, the easier it is to determine that the other vehicle CB will cut in front of the preceding vehicle CC. Note that it is also possible to use the relative speed Vr between the own vehicle CA and the other vehicle CB instead of the speed difference ΔV (=Vt−Vs) between the other vehicle speed Vt and the preceding vehicle speed Vs. In the ACC following state, the own vehicle speed Vn is equal to the preceding vehicle speed Vs.

The rear cut-in determination unit 16 calculates a collision prediction time TTC based on the inter-vehicle distance D1 between the own vehicle CA and the other vehicle CB and the relative speed Vr, which is the difference between the own vehicle speed Vn and the other vehicle speed Vt, and determines whether the other vehicle CB will cut in behind the own vehicle CA based on the collision prediction time TTC.

FIG. 5 shows an example of a scenario in which the other vehicle CB cuts in. In FIG. 5, the relative speed between the own vehicle speed Vn and the other vehicle speed Vt is Vr (Vr=Vt−Vn). In this scene, the relative speed Vr is negative, that is, the speed of the own vehicle Vn is greater than the speed of the other vehicle Vt.

In this case, the rear cut-in determination unit 16 calculates the collision prediction time TTC using the following equation (2).

$$TTC = - D 1 / Vr \qquad ( 2 )$$

In the above equation (2), the collision prediction time TTC is calculated by dividing the inter-vehicle distance D1 between the own vehicle CA and the other vehicle CB by the relative speed Vr and multiplying the result by −1.

Then, if the collision prediction time TTC is smaller than a predetermined time threshold Tx, it is determined that the other vehicle CB will cut in behind the own vehicle CA (i.e., the first position P1). On the other hand, if the collision prediction time TTC is greater than the predetermined time threshold Tx, it is determined that the other vehicle CB will cut in front of the own vehicle CA, not behind the own vehicle CA. The time threshold Tx is a positive value, and is about 5 seconds, for example. However, the time threshold Tx may be zero or a negative value at near zero.

The driving assistance control unit 14 performs driving assistance processing based on the cut-in position identified by the cut-in position specifying unit 13. In this case, in the scene shown in FIG. 3, the driving assistance control unit 14 does not perform driving assistance processing when it determines that the other vehicle CB will cut in front of the preceding vehicle CC, but performs driving assistance processing when it determines that the other vehicle CB will cut in behind the preceding vehicle CC (i.e., immediately in front of the own vehicle CA).

In addition, in the scene shown in FIG. 5, the driving assistance control unit 14 does not perform driving assistance processing when it determines that the other vehicle CB will cut in behind the own vehicle CA, and performs driving assistance processing when it determines that the other vehicle CB will cut in front of the own vehicle CA.

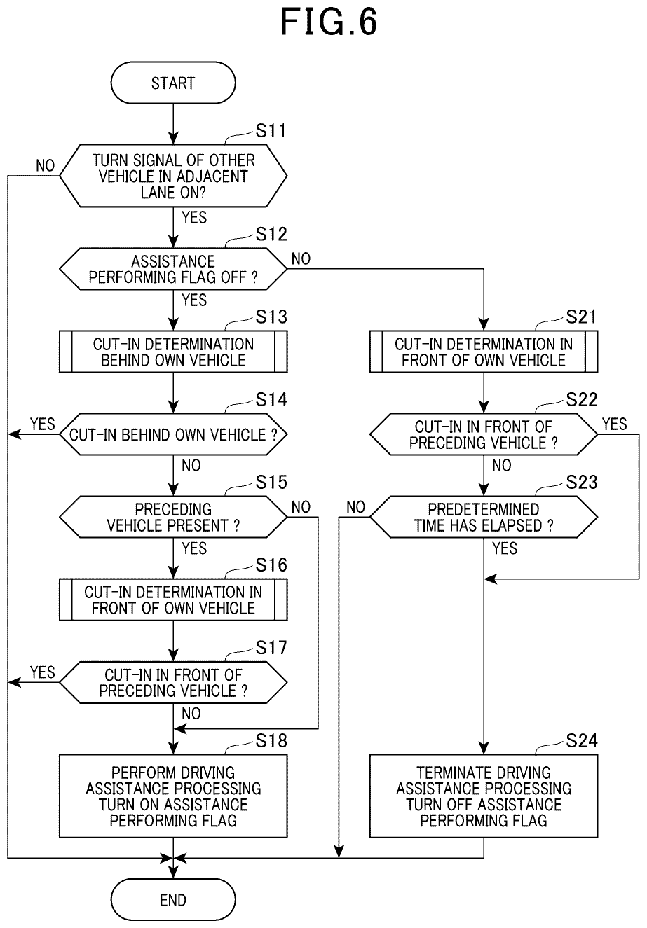

FIG. 6 is a flowchart showing a processing procedure of the driving assistance control. This process is repeatedly performed by the ECU 10 at predetermined intervals.

In FIG. 6, in step S11, it is determined whether the turn signal of the other vehicle CB traveling in the adjacent lane L2 is on. If the result of step S11 is affirmative, the process proceeds to the following step S12, and if the result of step S11 is negative, the process is temporarily terminated.

In step S12, it is determined whether assistance performing flag indicating that driving assistance processing is currently being performed is off. The assistance performing flag is initially off and is turned on while the driving assistance process is being performed. If the flag is off, the process proceeds to step S13.

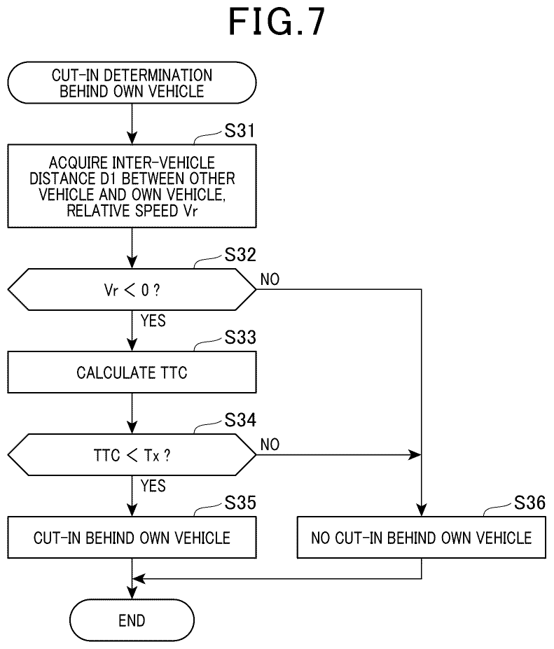

In step S13, a cut-in determination is made for an area behind the own vehicle. The present cut-in determination is performed according to the procedure shown in FIG. 7. In FIG. 7, in step S31, the inter-vehicle distance D1 and the relative speed Vr between the own vehicle CA and the other vehicle CB are acquired. In step S32, it is determined whether the relative speed Vr is negative. The relative speed Vr being positive rather than negative means that the own vehicle speed Vn is smaller than the other vehicle speed Vt. In this case, since the driver of the other vehicle CB has no intention of cutting in behind the own vehicle, the process proceeds to step S36, where it is determined that the other vehicle CB will not cut in behind the own vehicle CA.

Thereafter, in step S33, the collision prediction time TTC is calculated based on the inter-vehicle distance D1 and the relative speed Vr, and in the following step S34, it is determined whether the collision prediction time TTC is smaller than the time threshold Tx. Then, if the result of step S34 is affirmative, the process proceeds to step S35, where it is determined that the other vehicle CB will cut in behind the own vehicle CA. On the other hand, if the result of step S34 is negative, the process proceeds to step S36, where it is determined that the other vehicle CB will not cut in behind the own vehicle CA.

Returning to the explanation of FIG. 6, in step S14, it is determined whether the determination result in step S13 indicates that the other vehicle CB is about to cut in behind the own vehicle. At this time, if the determination result in step S13 is that the other vehicle CB will cut in behind the own vehicle CA, the process ends without performing driving assistance processing. On the other hand, if the determination result in step S13 is that the other vehicle CB will not cut in behind the own vehicle CA, the process proceeds to the subsequent step S15.

In step S15, it is determined whether a preceding vehicle CC is traveling ahead of the own vehicle CA. If the preceding vehicle CC is not traveling, the process proceeds to step S18, and if the preceding vehicle CC is traveling, the process proceeds to step S16. In a driving scene where there is no preceding vehicle CC, if the other vehicle CB does not cut in behind the own vehicle, it is assumed that the other vehicle will cut in front of the own vehicle, and in step S18, driving assistance processing is performed in preparation for the other vehicle CB cutting in. In addition, the assistance performing flag is turned on.

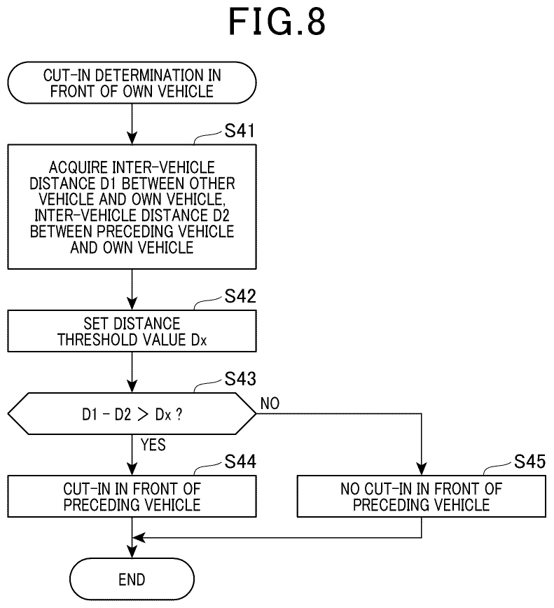

In step S16, a cut-in determination is made for a vehicle ahead of the own vehicle. The present cut-in determination is performed according to the procedure shown in FIG. 8. In FIG. 8, in step S41, the inter-vehicle distance D1 between the own vehicle CA and the other vehicle CB and the inter-vehicle distance D2 between the own vehicle CA and the preceding vehicle CC are acquired. In step S42, the distance threshold value Dx is set. The distance threshold value Dx may be set variably depending on the other vehicle speed Vt, and is set to a smaller value as the other vehicle speed Vt is greater than the preceding vehicle speed Vs (refer to FIG. 4). However, the distance threshold value Dx may be a predetermined value.

Thereafter, in step S43, it is determined whether the difference between the inter-vehicle distances D1 and D2 (=D1−D2) is greater than the distance threshold value Dx. Then, if the result of step S43 is affirmative, the process proceeds to step S44, where it is determined that the other vehicle CB will cut in front of the preceding vehicle CC. However, if the result of step S43 is negative, the process proceeds to step S45, where it is determined that the other vehicle CB will not cut in front of the preceding vehicle CC.

Returning to the explanation of FIG. 6, in step S17, it is determined whether the determination result in step S16 indicates that the other vehicle CB is about to cut in front of the preceding vehicle CC. At this time, if the determination result in step S16 is that the other vehicle CB will cut in front of the preceding vehicle CC, the process ends without performing driving assistance processing. On the other hand, if the determination result in step S16 is that the other vehicle CB will not cut in front of the preceding vehicle CC, the process proceeds to the subsequent step S18. In step S18, driving assistance processing is performed in preparation for the other vehicle CB cutting in, and the assistance performing flag is turned on.

According to steps S13 to S18, after the turn signal of the other vehicle CB is turned on, driving assistance processing is started based on the fact that it is not determined that the other vehicle CB will cut in behind the own vehicle CA, and it is not determined that the other vehicle CB will cut in front of the preceding vehicle CC.

After the assistance performing flag is turned on, the result of step S12 becomes affirmative, and the process proceeds to step S21, where the cut-in determination for the vehicle ahead is performed again. The present cut-in determination is preferably performed according to the procedure shown in FIG. 8 as described above. Thereafter, in step S22, it is determined whether the determination result in step S21 indicates that the other vehicle CB is about to cut in front of the preceding vehicle CC. At this time, if the determination result of step S21 is that the other vehicle CB will cut in front of the preceding vehicle CC, the process proceeds to step S24, and if the judgment result is that the other vehicle CB will not cut in front of the preceding vehicle CC at this time, the process proceeds to the subsequent step S23. Note that in a scene where there is no preceding vehicle CC, steps S21 and S22 are skipped.

In step S23, it is determined whether a predetermined time has elapsed since the start of driving assistance processing. The predetermined time is about 5 seconds, for example. If the result of step S23 is negative, the process ends. In this case, driving assistance processing currently being performed continues. If the result of step S23 is affirmative, the process proceeds to step S24.

In step S24, driving assistance processing currently being performed is terminated, and the assistance performing flag is turned off. According to steps S21 to S24, after the start of driving assistance processing, driving assistance processing is terminated based on whether it is determined that the other vehicle CB will cut in front of the preceding vehicle CC or a predetermined time has elapsed since the start of driving assistance processing.

According to the present embodiment described above in detail, the following excellent effects can be obtained.

When it is determined that the turn signal is turned on on the own lane L1 side of the other vehicle CB, the cut-in position of the other vehicle CB on the own lane L1 is identified, and driving assistance processing is performed based on the identified cut-in position. In this case, if the cut-in position of the other vehicle CB is not immediately in front of the own vehicle CA, the unnecessary driving assistance processing is suppressed from being performed. This makes it possible to realize the driving assistance device that performs appropriate driving assistance processing in the own vehicle CA.

When the preceding vehicle CC is traveling ahead of the own vehicle CA on the own lane L1, it is determined whether the other vehicle CB will cut in ahead of the preceding vehicle CC, and when it is determined that the other vehicle CB will cut in ahead of the preceding vehicle CC, driving assistance processing is not performed. In this case, it is possible to perform appropriate driving assistance processing while taking into consideration that driving assistance processing is unnecessary in a scene where the other vehicle CB cuts in front of the preceding vehicle CC.

Based on the inter-vehicle distance D1 between the own vehicle CA and the other vehicle CB and the inter-vehicle distance D2 between the own vehicle CA and the preceding vehicle CC, it is possible to determine whether the preceding vehicle CC or the other vehicle CB is ahead of the own vehicle CA, and to predict whether the other vehicle CB will cut in front of or behind the preceding vehicle CC. Therefore, driving assistance processing can be performed appropriately by determining whether the other vehicle CB will cut in front of the preceding vehicle CC based on the inter-vehicle distances D1 and D2.

If the traveling speed of the other vehicle CB is higher than that of the preceding vehicle CC, even if the other vehicle CB is positioned behind the preceding vehicle CC, it is possible that the other vehicle CB will overtake the preceding vehicle CC and cut in front of the preceding vehicle CC. Taking this into consideration, the distance threshold value Dx is set to a smaller value as the traveling speed of the other vehicle CB is higher than the traveling speed of the preceding vehicle CC. This allows appropriate cut-in determination to be made based on the traveling conditions of the other vehicle CB and the preceding vehicle CC.

It is determined whether the other vehicle CB will cut in behind the own vehicle CA in the own lane L1, and when it is determined that the other vehicle CB will cut in behind the own vehicle CA, driving assistance processing is not performed. In this case, appropriate driving assistance processing can be performed while taking into consideration that driving assistance processing is unnecessary in a scene where the other vehicle CB cuts in behind the own vehicle CA.

According to the collision prediction time TTC of the own vehicle CA with the other vehicle CB, it is possible to predict whether the other vehicle CB will come into contact with the own vehicle CA when the other vehicle CB enters the own lane L1, and thus it is possible to determine whether the other vehicle CB can cut in just in front of the own vehicle CA. Therefore, by determining whether the other vehicle CB will cut in behind the own vehicle CA based on the collision prediction time TTC, the cutting-in position of the other vehicle CB can be properly identified.

When it is determined that the turn signal is turned on in the other vehicle CB, driving assistance processing is started based on the fact that it is not determined that the other vehicle CB will cut in behind the own vehicle CA and that the other vehicle CB will not cut in front of the preceding vehicle CC. In addition, after the start of driving assistance processing, driving assistance processing is terminated based on whether it is determined that the other vehicle CB will cut in front of the preceding vehicle CC or a predetermined time has elapsed since the start of driving assistance processing. In this case, when the turn signal of the other vehicle CB in the adjacent lane L2 is turned on and there is an indication that the other vehicle is about to cut into the lane L1, driving assistance processing is initiated after confirming that the other vehicle is not cutting in behind the own vehicle, and the own vehicle can then prepare for the cutting in while monitoring the cutting in situation of the other vehicle CB in front of the own vehicle. This allows for safe and appropriate driving assistance processing.

### Other Embodiments

The above embodiment may be modified as follows, for example.

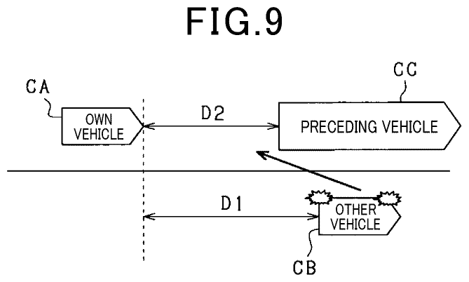

If the preceding vehicle CC traveling in front of the own vehicle CA is a large vehicle such as a bus or truck, its long overall length may make it difficult for the other vehicle CB to overtake the preceding vehicle CC and cut in front of it. Specifically, in the scene shown in FIG. 9, for example, the inter-vehicle distance D1 between the own vehicle CA and the other vehicle CB is greater than the inter-vehicle distance D2 between the own vehicle CA and the preceding vehicle CC, and it is expected that the other vehicle CB will cut in front of the preceding vehicle CC, however, if the preceding vehicle CC is a large vehicle, it is considered more desirable for the other vehicle CB to cut in behind the preceding vehicle CC rather than in front of it. Taking this into consideration, when the preceding vehicle CC is determined to be a large vehicle, the distance threshold value Dx may be set to a larger value than when the preceding vehicle CC is not a large vehicle.

Specifically, in step S42 of FIG. 8, the ECU 10 determines whether the preceding vehicle CC is a large vehicle whose overall length is equal to or greater than a predetermined length (large vehicle determination unit). The predetermined length is 10 m, for example. In this case, when the preceding vehicle CC is recognized as a bus or a truck based on an image of a rear end of the preceding vehicle CC in a camera image, for example, the preceding vehicle CC may be determined to be a large vehicle. Alternatively, if the preceding vehicle CC is towing a towed vehicle such as a trailer, the preceding vehicle CC may be determined to be a large vehicle. It is also possible to determine that the preceding vehicle CC is a large vehicle through inter-vehicle communication with the preceding vehicle CC. Then, if the preceding vehicle CC is a large vehicle, the distance threshold value Dx is set to a larger value than if the preceding vehicle CC is not a large vehicle. This makes it difficult for the relationship D1−D2>Dx to be established, increasing the possibility that the other vehicle CB will be determined to cut in immediately in front of the own vehicle CA rather than in front of the preceding vehicle CC. Therefore, the own vehicle CA can perform the driving assistance processing preparation for the other vehicle CB cutting in behind the large vehicle. According to the present configuration, it is possible to properly determine the cut-in determination of the other vehicle CB.

In the above embodiment, the process of identifying the cut-in position of the other vehicle CB is configured to perform the front cut-in determination process to determine whether the other vehicle CB will cut in front of the preceding vehicle CC, and the rear cut-in determination process to determine whether the other vehicle CB will cut in behind the own vehicle CA, however, this can be changed to a configuration in which only one of these processes is performed.

The control device and methods described in the present disclosure may be realized by a dedicated computer provided by configuring a processor and memory programmed to perform one or more functions embodied by the computer program. Alternatively, the control device and method described in the present disclosure may be implemented by a dedicated computer provided by configuring a processor with one or more dedicated hardware logic circuits. Alternatively, the control device and methods described in the present disclosure may be realized by one or more dedicated computers composed of a processor and memory programmed to perform one or more functions, in combination with a processor composed of one or more hardware logic circuits. In addition, the computer program may also be stored in a computer-readable, non-transitory tangible storage media as instructions to be performed by a computer.

What is claimed is:

1. A driving assistance device that, when an other vehicle cuts into an own lane in which an own vehicle is traveling from a lane adjacent to the own lane in which the own vehicle is traveling, performs driving assistance processing of the own vehicle regarding a cutting-in of the other vehicle, the driving assistance device comprising:
a turn signal determination unit that determines whether a turn signal has been turned on in the other vehicle on the own lane side;
a cut-in position specifying unit that specifies a cut-in position in the own lane at which the other vehicle will cut in when it is determined that the turn signal has been turned on in the other vehicle; and
a driving assistance control unit that performs driving assistance processing based on the cut-in position specified by the cut-in position specifying unit.

2. The driving assistance device according to claim 1, wherein
the cut-in position specifying unit includes a front cut-in determination unit that, when a preceding vehicle is traveling ahead of the own vehicle in the own lane, determines whether the other vehicle will cut in front of the preceding vehicle; and
the driving assistance control unit does not perform driving assistance processing when it is determined that the other vehicle will cut in front of the preceding vehicle.

3. The driving assistance device according to claim 2, wherein
the front cut-in determination unit determines whether the other vehicle will cut in front of the preceding vehicle based on an inter-vehicle distance between the own vehicle and the other vehicle in the traveling direction of the own vehicle and an inter-vehicle distance between the own vehicle and the preceding vehicle in the traveling direction of the own vehicle.

4. The driving assistance device according to claim 3, wherein
when the inter-vehicle distance between the own vehicle and the other vehicle is defined as D1, the inter-vehicle distance between the own vehicle and the preceding vehicle is defined as D2, and a distance threshold is defined as Dx,
the front cut-in determination unit determines that the other vehicle will cut in front of the preceding vehicle when D1−D2>Dx is satisfied;
the front cut-in determination unit determines that the other vehicle will cut in immediately in front of the own vehicle, not in front of the preceding vehicle, when D1−D2>Dx is not satisfied; and
the greater a traveling speed of the other vehicle relative to a traveling speed of the preceding vehicle, the smaller the distance threshold value Dx is set.

5. The driving assistance device according to claim 3, wherein
the driving assistance device includes a large vehicle determination unit that determines whether the preceding vehicle is a large vehicle having an overall length equal to or greater than a predetermined length;
when the inter-vehicle distance between the own vehicle and the other vehicle is defined as D1, the inter-vehicle distance between the own vehicle and the preceding vehicle is defined as D2, and a distance threshold is defined as Dx,
the front cut-in determination unit determines that the other vehicle will cut in front of the preceding vehicle when D1−D2>Dx is satisfied;
the front cut-in determination unit determines that the other vehicle will cut in immediately in front of the own vehicle, not in front of the preceding vehicle, when D1−D2>Dx is not satisfied; and
when the large vehicle determination unit determines that the preceding vehicle is a large vehicle, the distance threshold value Dx is set to a larger value than when the preceding vehicle is not a large vehicle.

6. The driving assistance device according to claim 1, wherein
the cut-in position specifying unit has a rear cut-in determination unit that determines whether the other vehicle will cut in behind the own vehicle in the own lane; and
the driving assistance control unit does not perform driving assistance processing when it is determined that the other vehicle will cut in behind the own vehicle.

7. The driving assistance device according to claim 6, wherein
the rear cut-in determination unit calculates a collision prediction time based on an inter-vehicle distance between the own vehicle and the other vehicle in the traveling direction of the own vehicle and a relative speed that is a difference between a own vehicle speed that is a traveling speed of the own vehicle and another vehicle speed that is a traveling speed of the other vehicle, and determines whether the other vehicle will cut in behind the own vehicle based on the collision prediction time.

8. The driving assistance device according to claim 1, wherein
the cut-in position specifying unit include:
a front cut-in determination unit that, when a preceding vehicle is traveling ahead of the own vehicle in the own lane, determines whether the other vehicle will cut in front of the preceding vehicle; and
a rear cut-in determination unit that determines whether the other vehicle will cut in behind the own vehicle in the own lane; wherein
when it is determined that the turn signal has been turned on in the other vehicle, the driving assistance control unit starts driving assistance processing based on the fact that the rear cut-in determination unit does not determine that the other vehicle will cut in behind the own vehicle and the front cut-in determination unit does not determine that the other vehicle will cut in front of the preceding vehicle; and
the driving assistance control unit terminates driving assistance processing based on whether the front cut-in determination unit determines that the other vehicle will cut in front of the preceding vehicle after the start of driving assistance processing, or based on the fact that a predetermined time has elapsed since the start of driving assistance processing.

9. A driving assistance device that, when an other vehicle cuts into an own lane in which an own vehicle is traveling from a lane adjacent to the own lane in which the own vehicle is traveling, performs driving assistance processing of the own vehicle regarding a cutting-in of the other vehicle, the driving assistance device comprising:
one or more processors; and
a memory storing instructions that when performed by the one or more processors causes the driving assistance device to perform:
determining whether a turn signal has been turned on in the other vehicle on the own lane side;
specifying a cut-in position in the own lane at which the other vehicle will cut in when it is determined that the turn signal has been turned on in the other vehicle; and
performing driving assistance processing based on the specified cut-in position.

10. A program for performing, when an other vehicle cuts into an own lane in which an own vehicle is traveling from a lane adjacent to the own lane in which the own vehicle is traveling, performs driving assistance processing of the own vehicle regarding a cutting-in of another vehicle, the program comprising:
the program to be performed by a processor includes:
a turn signal determination step of determining whether a turn signal has been turned on in the other vehicle on the own lane side;
a cut-in position specifying step of specifying a cut-in position in the own lane at which the other vehicle will cut in when it is determined that the turn signal has been turned on in the other vehicle; and
a driving assistance control step of performing driving assistance processing based on the cut-in position specified by the cut-in position specifying step.
